(19) United States
(12) Patent Application Publication
(10) Pub. No.: US 2008/0123712 A1
(43) Pub. Date: May 29, 2008

(54) Measuring water vapor in high purity gases

(75) Inventors: Xin Zhou, Racho Cucamonga, CA (US); Gregory M. Sanger, Chico, CA (US)

Correspondence Address: MINTZ, LEVIN, COHN, FERRIS, GLOVSKY AND POPEO, P.C;ATTN: PATENT INTAKE CUSTOMER NO. 64046, ONE FINANCIAL CENTER, BOSTON, MA, 02111, US

(73) Assignee: SpectraSensors, Inc.

(21) Appl. No.: 11/818,617

(22) Filed: Jun. 14, 2007

Related U.S. Application Data
(60) Provisional application No. 60/814,013, filed on Jun. 15, 2006.

(51) Int. Cl. H01S 3/22

(52) U.S. Cl. 372/55

(57) ABSTRACT

Low concentrations of water vapor in a gas stream can be detected and quantified using absorption spectroscopy in the infrared spectral region. Absorption spectra can recorded using tunable diode lasers as the light source. Modulation of the laser signal and demodulation of the resultant detector response yields dependable measurements that may be conducted with very little maintenance in demanding environments.

### RELATED APPLICATION

The present patent application claims priority under 35 U.S.C. §119 to U.S. Provisional Patent Application Ser. No. 60/814,013, filed on Jun. 15, 2006, and entitled “Detection of Trace Levels of Moisture in Pure Gas Streams”, the entire disclosure of which is incorporated by reference herein.

### TECHNICAL FIELD

The subject matter disclosed herein relates to detection and measurements of trace levels of water vapor.

### BACKGROUND

Currently available techniques for characterizing water vapor in high purity gas streams suffer from various drawbacks. For example, maintenance and calibration issues in the field may make their use cumbersome and costly. In addition, these techniques may be difficult to calibrate, may drift over time, and may generally fail to provide rapid response and recovery times.

One conventional technique measures the dew point of the water vapor in a gas mixture by flowing the gas mixture over a chilled mirror. Moisture in the sampled gas mixture condenses on the mirror when the mirror's temperature is at or below the dew point of the gas mixture. To estimate the water vapor concentration, the temperature of the mirror is scanned through an appropriate range from warmer to cooler, and the temperature is measured when condensation begins on the mirror surface. The dew point is a function of the relative humidity of the gas mixture, which is readily converted to a is a function of the relative humidity of the gas mixture, which is readily converted to a partial pressure or concentration of water vapor in the gas mixture. Detection of condensation on the mirror may be accomplished visually or by optical means. For example, a light source may be reflected off the mirror into a detector and condensation detected by changes in light reflected from the mirror. The observation may also be done by eye. However, the exact point at which condensation begins is often not readily distinguishable in this manner. Also, because the mirror temperature passes dynamically through the dew point, the error in the measurement tends to be substantial. Other, lower vapor pressure components of the gas mixture, such as higher molecular weight hydrocarbons, alcohols, and glycols, may also condense on the mirror as it cools. Automated on-line systems may be unable to distinguish between gas mixture components that condense on the mirror surface, and manual systems generally require highly skilled operators.

Another conventional technique uses two closely spaced, parallel windings coated with a thin film of phosphorous pentoxide (P₂O₅). An electrical potential applied to the windings electrolyzes water molecules adsorbed by the coatings to hydrogen and oxygen. The current consumed by the electrolysis reaction is proportional to the mass of water vapor entering the sensor. The flow rate and pressure of the incoming sample must be controlled precisely to maintain a standard sample mass flow rate into the sensor. However, contamination from oils, liquids or glycols on the windings causes drift in the readings and may damage the sensor. The sensor reacts slowly to sudden changes in moisture, as the absorption reaction on the surfaces of the windings takes some time to equilibrate. Large amounts of water in a gas mixture (commonly known as “slugs”) may wet the surface which requires tens of minutes or hours to “dry-down” before accurate measurements are again possible. As such, effective sample conditioning and removal of liquids is essential when using this sensor.

Still another conventional technique utilizes piezoelectric adsorption. Such an instrument compares changes in the frequency of hygroscopically coated quartz oscillators. As the mass of the crystal changes due to adsorption of water vapor on the hygroscopic coating, the resonant frequency of the quartz crystal changes. The sensor is a relative measurement that requires an integrated calibration system with desiccant dryers, permeation tubes and sample line switching. These instruments may also suffer from interference by glycol, methanol, and other polar molecules as well as from damage from hydrogen sulfide. However, the required calibration system is not as precise and adds to the cost and mechanical complexity of the system. Labor for frequent replacement of desiccant dryers, permeation components, and the sensor heads greatly increase operational costs. Additionally, as with the electrolysis-based system described above, slugs of water may render the system nonfunctional for long periods of time as the sensor head “dries-down.”

Aluminum and silicon oxide sensors have also been used. These sensors include an inert substrate material and two dielectric layers, one of which is sensitive to humidity. Water molecules in the gas mixture pass thru pores on an exposed surface of the sensor and cause a change to a physical property of the layer beneath it. In an aluminum oxide sensor, two metal layers form the electrodes of a capacitor. The dielectric constant of the sensor changes as water molecules adsorb to its surface. The sensor impedance is correlated to the water concentration. A silicon oxide sensor is an optical device whose refractive index changes as water is absorbed into the sensitive layer. When light is reflected through the substrate, a wavelength shift can be detected on the output which can be precisely correlated to the moisture concentration.

With aluminum and silicon oxide sensors, water molecules take time to enter and exit the pores so some wet-up and dry down delays will be observed, especially after a slug. Contaminants and corrosives may damage and clog the pores causing a “drift” in the calibration. As with piezoelectric and electrolytic sensors, these sensors are susceptible to interference from glycol, methanol, and other polar organic compounds. The calibration may drift as the sensor's surface becomes inactive due to damage or blockage, so the calibration is most reliable at the beginning of the sensor's life.

### SUMMARY

In one aspect, trace amounts of water vapor in a high purity gas are quantified by directing a beam of light at a selected wavelength through a high purity gas that containing water vapor at low concentrations. The selected wavelength coincides with a water vapor absorption feature that is resolvable from an absorption background of the high purity gas. An absorption is quantified at the selected wavelength in the high purity gas over a path length, and a water vapor concentration in the high purity gas is determined based on the quantified absorption. The determined water vapor concentration can then be promoted, in some optional variations by displaying, transmitting, storing the determined water vapor concentration, or the like.

In a second interrelated aspect, an apparatus includes a laser light source that emits a light beam that includes a selected wavelength that coincides with a water vapor absorption feature that is resolvable from a gas absorption background of a high purity gas. A sample cell is included to contain the high purity gas containing water vapor at a concentration of less than or equal to approximately 0.1%. The sample cell provides a path length of greater than or equal to approximately 40 cm for the light beam through the high purity gas. A photodetector is positioned to quantify an intensity of light traversing the path length and to output a direct current data signal based on the quantified intensity. A microprocessor is configured to receive and interpret the direct current signal from the photodetector and to determine the water vapor concentration in the high purity gas based on the direct current data signal.

In optional variations, high purity gas can be contained within a sample cell that provides the path length. The absorption at the selected wavelength can be quantified with a photodetector that provides a detector output signal to a microprocessor. Light can be generated with a range of wavelengths that includes the selected wavelength. The generated light can be tuned across the range of wavelengths. A DC signal from a photodetector that the light beam impinges upon after traversing the high purity gas can be converted to an absorption spectroscopy signal by demodulating the DC signal, and the absorption spectroscopy signal can be analyzed to determine the water vapor concentration. The quantifying of the absorption at the selected wavelength can be accomplished using one of direct absorption spectroscopy, harmonic spectroscopy, photoacoustic spectroscopy, cavity ringdown spectroscopy, integrated cavity spectroscopy, and cavity enhanced spectroscopy. The water vapor concentration can optionally be less than or equal to approximately 0.1% or alternatively less than or equal to 1 ppm. The selected wavelength can be in a range of about 1359 to 1395 nm, about 1836 to 1907 nm, or about 2570 to 2750 nm. The selected wavelength can be chosen such that absorption of 1 ppmv of water vapor at the selected wavelength and a measurement pressure divided by a total background absorption of the high purity gas at the selected wavelength and the measurement pressure is greater than 1×10⁻⁶. The beam of light can be provided from a tunable diode laser that is tuned to provide a range of wavelengths comprising the selected wavelength. The gas mixture and the photodetector can be maintained at a constant temperature within a tolerance of approximately ±1° C. The sample cell can include two reflective mirrors configured to reflect the light beam between them one or more times before the light beam reaches the photodetector.

In a third interrelated aspect, trace amounts of water vapor are detected by generating a beam of light that includes a selected wavelength from a tunable laser. The selected wavelength is selected such that absorption of 1 ppmv of water vapor at the selected wavelength divided by absorption by the high purity gas at the selected wavelength is greater than 1×10⁻⁶. The beam of light is directed through a high purity gas that includes water vapor at a concentration of less than or equal to approximately 0.1%. An absorption is quantified at the selected wavelength in the high purity gas over a path length of greater than or equal to approximately 40 cm and at a pressure of approximately 1 atmosphere. A water vapor concentration is determined in the high purity gas based on the quantified absorption.

### DESCRIPTION OF THE DRAWINGS

This disclosure may be better understood upon reading the detailed description and by reference to the attached drawings, in which:

FIG. 1 is a process flow diagram illustrating a method of detecting and/or quantifying water vapor concentrations.

FIG. 2 is a schematic diagram showing an example of an absorption spectrometer;

FIG. 3 is a schematic diagram showing an example of a multipass absorption cell;

FIG. 4 is a chart that illustrates principles of wavelength modulation spectroscopy;

FIG. 5 is a chart showing an example of a DC signal and a 2f signal of wavelength modulation spectroscopy;

FIG. 6 is a block diagram of a measurement system;

FIG. 7 is a chart showing an example of a laser current drive signal;

FIG. 8 is a chart showing absorbance of water vapor in the wavelength range between about 1359 and 1395 nm; and

FIG. 9 is a chart showing absorbance of water vapor in the wavelength range between about 1836 and 1861 nm.

### DETAILED DESCRIPTION

Absorption spectroscopy can be used to measure low concentrations of water vapor in high purity gases, which may also be characterized as single or nearly single composition gases. Such gases can include, but are not limited to argon (Ar), helium (He), nitrogen (N₂), oxygen (O₂), carbon monoxide (CO), carbon dioxide (CO₂), hydrogen (H₂), and the like. In general, a light beam of suitable wavelength is passed through a sample of a high purity gas that is contained within a sample cell. As light passes through the gas, some of its intensity is absorbed by trace gas molecules of compounds that absorb at that specific wavelength. The amount of light absorbed is dependent on the concentration (partial pressure) of compounds that absorb at the specific wavelength and can therefore be used to calculate the concentration. This arrangement is suitable when the background gas has no or very weak absorption features in the spectral region being used for the trace gas measurement.

Near infrared radiation generally lacks sufficient photon energy to induce absorption by electronic transitions such as those induced by ultraviolet radiation. Therefore, IR absorption is restricted to compounds with small energy differences in the possible vibrational and rotational states of the molecules. For a molecule to absorb IR radiation, the vibrations or rotations within a molecule must cause a net change in the dipole moment of the molecule. The alternating electrical field of the radiation interacts with fluctuations in the dipole moment of the molecule. The energy of the incident light radiation is

E=hν (1)

where E is the photon energy, h is Planck's constant and ν is the frequency of the light. If E matches the energy necessary to excite a vibrational mode of a molecule, then radiation will be absorbed causing a change in the amplitude of this molecular vibration. The two main types of molecular motion, which includes relative motion between atoms making up the molecule, involve stretching and vibration of inter-atomic bonds.

Stretching transitions require moderate energies and are therefore quite useful to IR absorption spectroscopy. In stretching transitions, the inter-atomic distance changes along bond axes, and the resultant absorbance of IR by gas-phase molecules yield line spectra sufficiently spaced apart to allow detection. In liquids or solids, these lines broaden into a continuum due to molecular collisions and other interactions such that they cannot be measured by IR absorption spectroscopy.

The relative positions of atoms in molecules are not fixed, but are rather subject to a number of different vibrations relative to other atoms in the molecule. A specific molecular motion requires a corresponding quantum of activating photon energy. Therefore, an incident photon's energy must be of exactly the right wavelength to be absorbed into the molecule. Thus, if a gas containing a molecule that absorbs at a given wavelength λ is illuminated by a beam of light of wavelength λ, some of the incident photons will be absorbed as it passes through the gas. This absorbance A_{i,λ} is calculated from the beam power incident on the sample P₀ and the beam power passing through the sample P as follows:

A_{i,xλ}=−ln(P/P₀) (2)

In accordance with Beer-Lambert's Law, the absorbance A_{i,λ} due to a specific gas-phase compound i at the incident wavelength λ is directly proportional to its concentration Cᵢ in the cell:

A_{i,λ}=Cᵢ ε_{i,λ}L (3)

where ε_{i,λ} is the extinction coefficient for the compound at the incident wavelength, and L is the path length of the absorption/sample cell.

An analyzer used in connection with the subject matter disclosed here can be used to make water vapor concentration measurements at low levels of water vapor in high purity gases. In general, such an analyzer includes a source of incident light, such as a laser, one or more detectors with sensitivity in the wavelength range of the light source, and one or more absorption cells, each arranged such that the gas provides a path length L though which a beam from the light source passes before reaching the detector. Control electronics, such as a microprocessor, and user accessible input/output channels can also be included. The following is a general description of various examples of such devices and their operation.

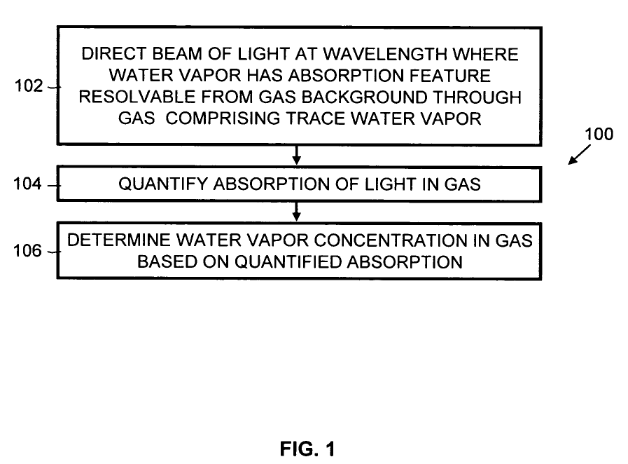

FIG. 1 shows a flow chart 100 of a method of analyzing water vapor concentrations. In general, a beam of light is directed through a high purity gas that contains a low concentration of water vapor at 102. The light includes at least one wavelength at which water vapor has an absorption feature that is resolvable from the background of the gas. The gas can have a water vapor concentration of less than or equal to approximately 0.1%. Alternatively, the water vapor concentration can be less than approximately 1 ppm. At 104, absorption of light in the gas mixture is quantified over an absorption path length that may, in one variation, be greater than or equal to approximately 40 cm. The water vapor concentration in the gas can be determined at 106 using the quantified absorption and a calibration function. The measurement of transmitted intensity can be performed with a photodetector such as described below. The recording of the absorption spectrum can be performed with a data analysis device, such as for example a microprocessor.

In one implementation, a sample of a gas containing water vapor is illuminated by a laser light source that emits light either in a continuous or a pulsed beam. The light source can be a laser such as a tunable diode laser (TDL) or alternatively a fixed wavelength laser light source operating at a specific wavelength chosen to have detectable water vapor absorption without interference from background absorbance by the main component of the gas. The calibration function can be determined based on analysis of one or more samples of gas containing water vapor at known concentrations. The samples are analyzed using the analyzer to be used in the above method. Absorption of light at the selected wavelength is quantified for each sample, and a fitting function is applied to relate water vapor concentration to measured absorption. The calibration function can be a linear relationship or it can alternatively be a more complex mathematical function.

Examples of tunable lasers that can be used are the distributed feedback laser (DFB), the vertical cavity surface emitting laser (VCSEL), and the horizontal cavity surface emitting laser (HCSEL). These lasers can be direct emitters or fiber coupled. Quantum cascade lasers can also be utilized as can other lasers capable of producing a beam of incident light in the desired wavelength range. Additional detail about these types of lasers is available in co-pending U.S. patent application Ser. No. 11/715,599, the disclosure of which is hereby incorporated by reference in its entirety.

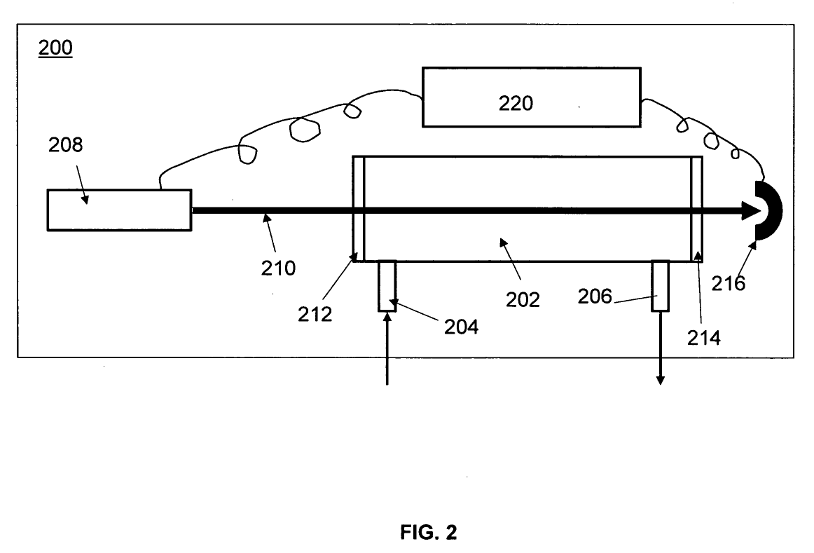

An illustrative implementation of an analyzer as disclosed herein is depicted schematically in FIG. 2, which shows an analyzer 200 that implements various aspects of the current subject matter. In this implementation, a gas sample is contained within a sample cell 202. The gas sample can be directed into the sample cell 202 via an inlet 204 and flushed from the sample cell 202 via an outlet 206. In some variations, the inlet 204 and the outlet 206 can include valves that can seal the inner volume of the sample cell 202 to obtain a static measurement of a fixed volume of gas. If there are no inlet and outlet valves, or if the inlet and outlet valves are open, the system can be used in a continuous or semi-continuous flow mode, such as for example to continuously or semi-continuously monitor the concentration of a target analyte in a flowing gas stream. For continuous or semi-continuous operation, all or part of a gas stream is directed into the sample cell 202 via the inlet 204 and flushed out of the sample cell 202 via the outlet 206 by the flow of the gas. Flow through the sample cell 202 can be caused by a pressure differential created by a pump or some other mechanism.

A light source 208 that provides light with at least a wavelength where water vapor absorption can be resolved from the gas background absorption generates a continuous or pulsed beam 210 that is directed through the gas volume of the sample cell 202. In the example shown in FIG. 2, the sample cell includes windows 212 and 214 that allow the light beam 210 to enter and exit the cell. The light beam 210 is directed onto a photodetector or other device for quantifying the intensity of incident light 216 as the light beam exits the sample cell 202. The photodetector 216 is electronically coupled to a control unit 220 that can optionally also be electronically coupled to the light source 208 as shown in FIG. 2. The control unit 220 can include one or more processors coupled to a memory that stores instructions in computer readable code. When executed on the processor or processors, the instructions can implement a method, such as for example that described above, to analyze the absorption at the second or reference wavelength to infer and compensate for the absorption at the first or target wavelength that is due to the background analyte. Once the absorption at the first or target wavelength is so compensated, the control unit 220 can calculate the target analyte concentration.

If the control unit 220 is electronically connected to the light source 208, it can optionally control the light source. For example, if the light source 208 is a tunable diode laser, such as one of those described in U.S. patent application Ser. No. 11/715,599, the control unit can control the scan rate and also interpret the direct voltage measurements by the photodetector 216 to convert them to modulated values. The control unit can also adjust the modulation amplitude as necessary to improve spectral resolution.

Other analyzer configurations besides that shown in FIG. 2 are possible, including but not limited to those described in co-pending U.S. patent application Ser. No. 11/715,599. The sample cell 202 can be a single pass design in which the light beam 210 from the light source 208 passes once through the gas volume of the sample cell 202 before exiting the sample cell 202. In this configuration, the optical path length is effectively the length of the sample cell 202. It is also possible to use one or more mirrors that reflect the light beam 210 such that it passes through the sample volume more than once before exiting the sample cell 202. A Herriot cell (described in full detail in co-pending U.S. patent application Ser. No. 11/715,599), in which the light beam 210 is reflected between two spherical mirrors numerous times to create a very long optical path length, can also be used. The optical path length can be selected based on the strength of the absorption features being used in a measurement and the concentration of the gases being analyzed.

The path length of the sample cell can be varied depending on the strength of the specific absorption line of interest or the magnitude of the difference between the absorption line of interest and interfering absorption lines from other gas species present. A cell of insufficient length can not provide sufficient sensitivity while one of excessive length can absorb the entirety of the incident light such that no measurable signal reaches the detector (a situation called saturation).

In some cases, the water vapor concentration can be very small or not readily distinguishable from other components present in the gas. In such cases, the length of the cell can be increased to increase the sensitivity of the measurement. As equation 3 states, A_{i,λ} is directly proportional to the path length L over which the laser beam traverses the gas mixture. Thus, a cell that is twice as long will absorb twice as much light etc. Therefore, in some implementations of the analyzers described here, sample cells can be employed having path lengths on the order of many meters or even thousands of meters.

To achieve longer optical path lengths without the use of extremely long sample cells, sample cell configurations within the scope of this disclosure can also include the use of one or more mirrors to reflect the beam such that the beam passes through the sample contained in the sample cell two or more times. In such a multipass configuration, the beam can enter and exit the cell through the same window or through different windows. In some implementations, windowless sample cell configurations can be utilized in which, for example, the laser source and/or the photodetector are contained within the sample cell.

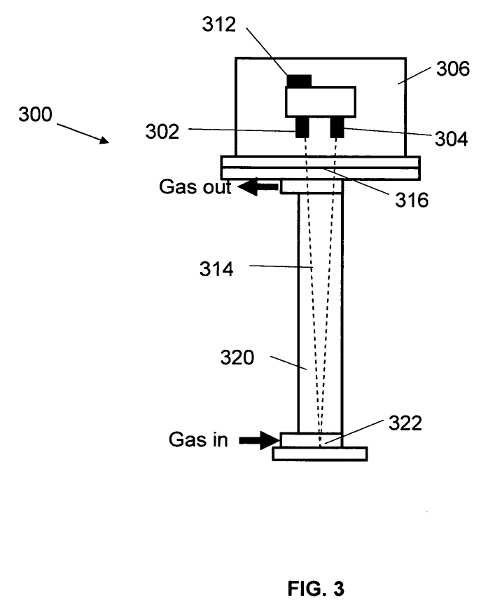

One example of such a multipass sample cell configuration is shown in FIG. 3, which depicts a two-pass absorption cell and laser/detector head 300. A laser 302 and photodetector 304 are positioned in an optical head 306 mounted to a baseplate 310 whose temperature is controlled by a thermoelectric cooler (TEC) 312. The incident laser light 314 is directed out of the optical head 306 through a window 316 into the sample cell 320. The light travels the length of the sample cell 320 twice as it is reflected at the far end of the cell by a flat mirror 322. The returning light is transmitted back through the window 316 and impinges on the photodetector 304. The analyzer shown in FIG. 2 can be modified to incorporate a multipass detector head as shown in FIG. 3.

The light source used for the absorption measurements disclosed can emit in the infrared (for example in a wavelength range of approximately 800 to 10,000 nm). The analyzer can utilize a laser whose spectral bandwidth is much narrower than the bandwidth of the absorption lines of interest. Such an arrangement allows for single line absorption spectroscopy in which it is not necessary to scan the entire width of the absorption line or even the peak absorption feature of the line. The wavelength of the laser can be chosen to be one at which there is a resolvable difference in the relative absorbance of water molecules and the other components of the gas to be measured. In one implementation, the laser frequency can be scanned (tuned) back and forth across the chosen absorption wavelength while a photodetector positioned at the opposite end of the beam path length quantifies the light intensity transmitted through the sample as a function of wavelength.

With the laser absorption spectrometers described herein, the tunable laser wavelength can be varied by changing the injection current while keeping the laser temperature constant. The temperature can be controlled by placing the laser in intimate contact with a thermoelectric cooler (Peltier cooler) whose temperature is measured with a thermistor and controlled by a feedback circuit. The control unit of a device, system, or apparatus as described herein can provide process control functions to regulate the system temperature.

In some implementations, an absorption spectrometer system can employ a harmonic spectroscopy technique in connection with its TDL light source. Harmonic spectroscopy as used in the disclosed subject matter involves the modulation of the TDL laser (DFB or VCSEL) wavelength at a high frequency (kHz-MHz) and the detection of the signal at a multiple of the modulation frequency. If the detection is performed at twice the modulation frequency, the term second harmonic or “2f” spectroscopy is used. Advantages to this technique include the minimization of 1/f noise, and the removal of the sloping baseline that is present on TDL spectra (due to the fact that the laser output power increases as the laser injection current increases, and changing the laser injection current is how the laser is tuned).

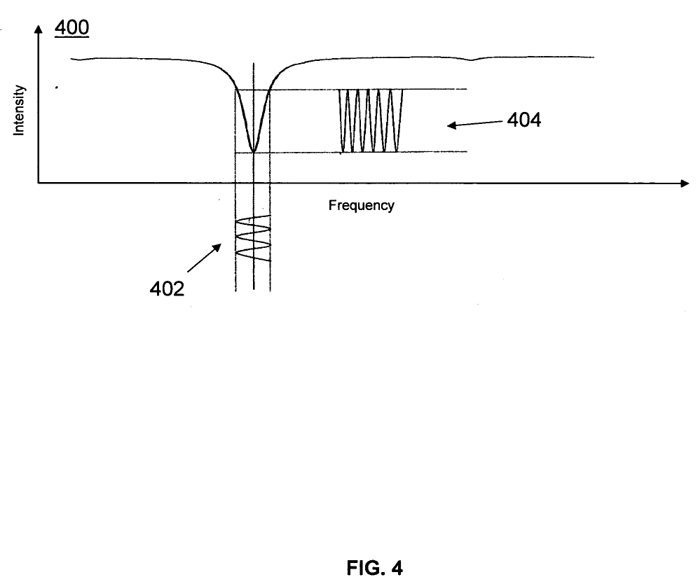

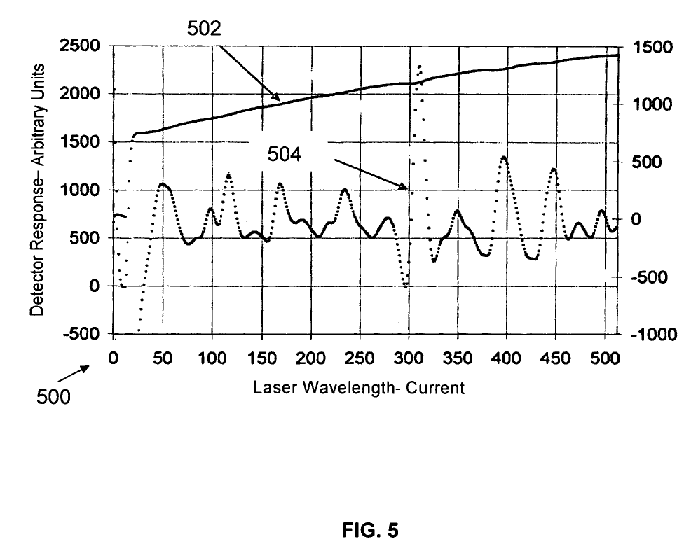

FIG. 4 shows an example of a laser scan 400 for use in harmonic spectroscopy. A combination of a slow ramp and a fast sinusoidal modulation of the wavelength 402 is used to drive the diode laser. The photodetector receives this modulated intensity signal 404. The N^{th} harmonic component is resolved by demodulating the received signal. Detection using the signal at the second harmonic (2f) can be used. The 2f lineshape is symmetric and peaks at line center due to the nature of even function. Additionally, the second harmonic (2f) provides the strongest signal of the even-numbered harmonics. FIG. 5 presents a chart 500 of a typical direct current laser intensity signal 502 and a demodulated 2f lineshape 504 vs. frequency. By shifting detection to higher frequency, 2f spectroscopy can significantly reduce 1/f noise thus provides a substantial sensitivity enhancement compared to direct absorption methods.

In another implementation, direct absorption spectroscopy can be used. In this implementation, the laser frequency is tuned over the selected absorption transition and the zero-absorption baseline can be obtained by fitting the regions outside the absorption line to a low-order polynomial. The integrated absorbance is directly proportional to the concentrations of absorbing species in the laser path length as well as the line strength of the transition. The absolute species concentration can be obtained without any calibration

Photodetectors used in the disclosed absorption spectrometers depend on the specific wavelengths of the lasers and absorption lines to be measured. One photodetector is an indium gallium arsenide (InGaAs) photodiode sensitive to light in the 1200 to 2600 nm wavelength region. For longer wavelengths, an indium arsenide photodiode, sensitive for wavelengths up to approximately 3.6 μm, can be used. Alternatively, indium antimonide detectors are currently available for wavelengths as long as approximately 5.5 μm. Both of the indium devices operate in a photovoltaic mode and do not require a bias current for operation. These photodetectors, which lack low frequency noise, are advantageous for DC or low frequency applications. Such detectors are also advantageous for high speed pulse laser detection, making them particularly useful in trace gas absorption spectroscopy. Other photodetectors, such as for example indium arsenide (InAs), silicon (Si), or germanium (Ge) photodiodes and mercury-cadmium-telluride (MCT) and lead-sulfide (PbS) detectors, may also be used.

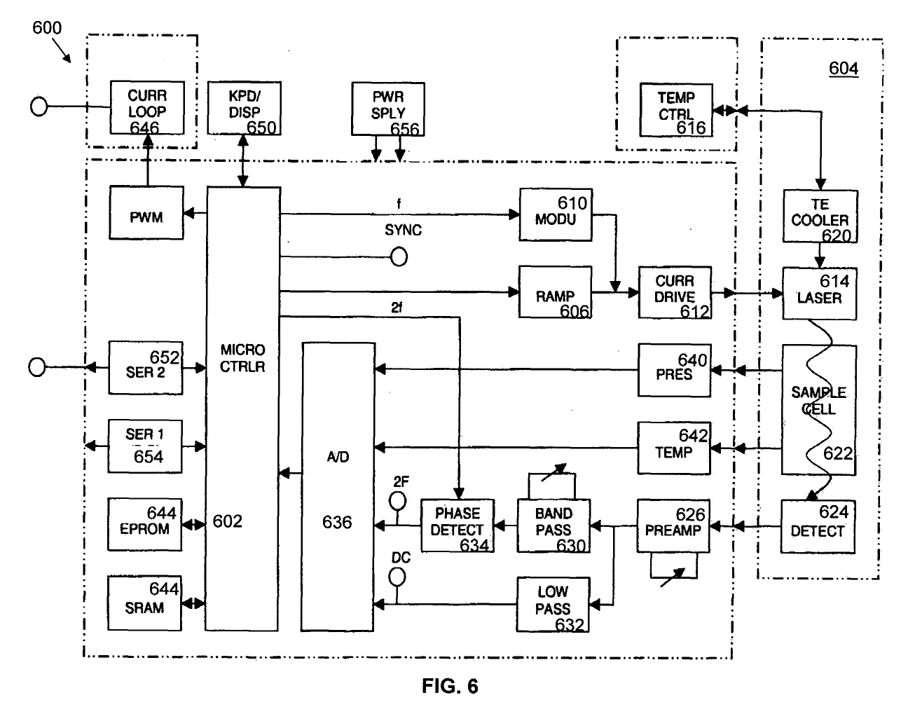

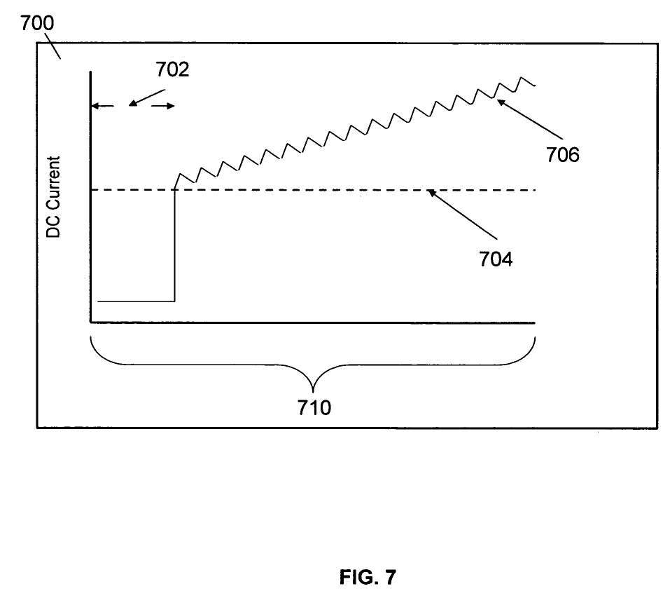

FIG. 6 is a diagram of a sensor system 600 that includes a control and data processing loop system with a microprocessor 602 in communication with a spectrometer 604. On command, a signal is generated by the microprocessor 602 in the form of a rectangular pulse. This pulse is generated periodically. In one implementation, a 263 msec wide pulse is generated every 0.25 seconds. Other pulse widths and generation frequencies can be utilized. Each pulse is directed toward a ramp generator 606 that creates a DC signal, an example of which is shown diagrammatically in FIG. 7. In addition to the ramp signal, a modulating sine wave, at for example 7.5 KHz, can be imposed on the current ramp by a modulator 610 for later use in small signal detection. This combined signal is directed to the laser current driver 612 and on to the laser 614 itself.

In this implementation, the laser temperature is held constant by a temperature controller board 616 and the current varied for tuning the laser wavelength. The temperature control loop uses a thermistor (not shown) located close to the laser 614 as the temperature input and a thermoelectric cooler 620 mounted as close (thermally) to the laser 614 as possible. TECs and thermistors can be positioned either directly adjacent to the laser diode or externally to the laser diode enclosure. The temperature controller 616 can be used to set the exact laser wavelength such that variation of the driving current can provide the tuning range which can, for example, be in the range of approximately ±0.3 cm⁻¹.

Cavity-ring down spectroscopy can also be utilized such that a pulsed or CW laser beam is injected into a cavity formed by at least one highly reflective mirror or at least one optical element forming a resonant optical cavity by means of total internal reflection of the light beam. Trace level absorption of a target gas can be detected by utilizing the photon decay time inside this high-finesse optical cavity. In some variations, other cavity-enhanced spectroscopic methods, such as for example integrated cavity output spectroscopy (ICOS), cavity attenuated phase shift spectroscopy (CAPS), cavity output autocorrelation spectroscopy (COAS), and the like, can be employed.

Photoacoustic spectroscopy can also be utilized. Some of the energy absorbed by target gas molecules will result in the rise of gas temperature. Temperature fluctuations thus can produce a pressure wave which can be detected by a suitable sensor. By measuring pressure at different wavelengths, a photoacoustic spectrum of the target molecule can be obtained to determine the concentration.

At the beginning of each measurement cycle, the current is held to zero to read the signal produced by the photodetector without laser input and thereby provide the zero for that measurement cycle. This zero can vary a small amount due to slight changes in the detector dark current and the electronic noise so it is advantageous to measure it during each detector cycle. Following determination of the zero, the current is rapidly increased to the laser threshold current. This current is then increased over the remainder of the cycle until the peak current is reached. The beam created from this signal is directed through the sample cell 622 and onto the detector 624 which can be a photodiode array or other comparable detector. The output current from the detector is first amplified by a preamplifier 626. The output of the preamplifier is split and sent to a bandpass filter 630 and a lowpass filter 632. The bandpass filter 630 is a narrowband filter that singles out the 2f signal at 15 KHz and directs it to a lock-in amplifier 634 whose reference is set at 15 KHz from a signal provided by the microprocessor. The lock-in amplifier 634 further amplifies the signal and directs it to an A-D board 636 and back into the microprocessor 602. The lowpass filter 632 provides the detector output except the 2f signal. This signal provides the microprocessor 602 with the zero for the system and is also a diagnostic tool.

The signal is developed and recorded by the microprocessor 602 for each cycle of the analyzer. The processor determines the concentration of the gas sample of interest by computing the absorbance of the gas as a ratio between the zero and the measured value of absorbance at the peak of the absorbance line. The absorbance is a function of the gas pressure and temperature in the sample cell 622 which are measured by appropriate means 642 and 644, respectively, whose outputs are supplied to the A/D board 636. The absorbance can be adjusted by a pressure/temperature calibration matrix stored in the microprocessor memory 644. This matrix is developed on an analyzer-by-analyzer basis. Alternatively, one or more corrective calculations can be performed based on measured temperature and pressure in the sample cell.

Once the corrected absorbance value is determined, the concentration can be computed using equation 3. In one implementation, this concentration can be converted into units of, for example lbs/mmscf, averaged four times, and sent to the outputs once per second. Outputs that can be included in this system are a 4-20 mA current loop 646, a visual display 650 and RS-232 or comparable serial ports 652 and 654. Power for the system is provided by an appropriately chosen power supply 656.

The chart of laser current vs. time 700 shown in FIG. 7 illustrates an example of the laser pulse profile that may be used in the disclosed analyzers. For each pulse cycle, A dynamic zero measurement is made during an initial period 702 when the laser current is well below the lasing threshold 704. Then, the laser current is ramped rapidly to at or above the lasing threshold 704, and a modulated laser tuning ramp with an alternating current voltage 706 is added to facilitate the 2f demodulation calculations as described above. At the end of the pulse cycle 710, the process is repeated. In one example, the pulse cycle last approximately 263 milliseconds. Other cycle periods are within the scope of this disclosure.

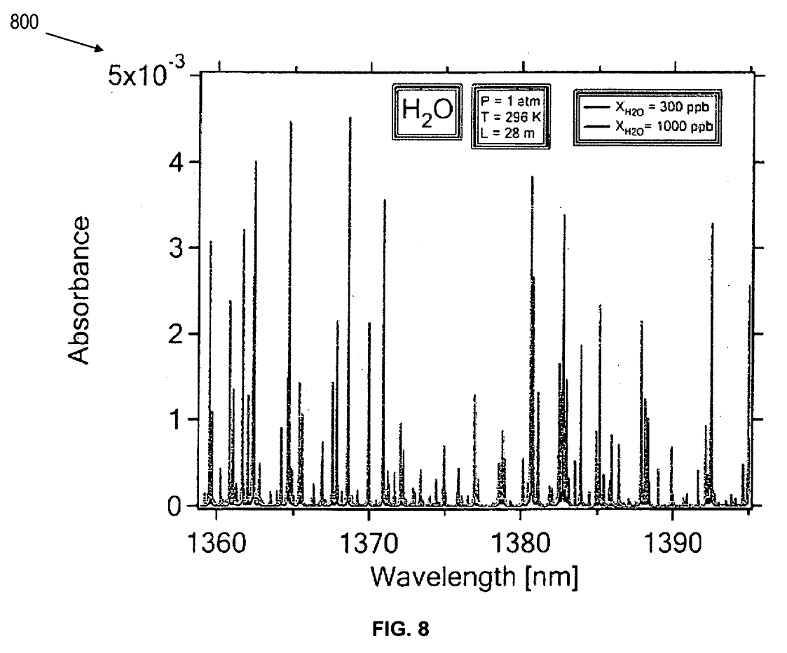

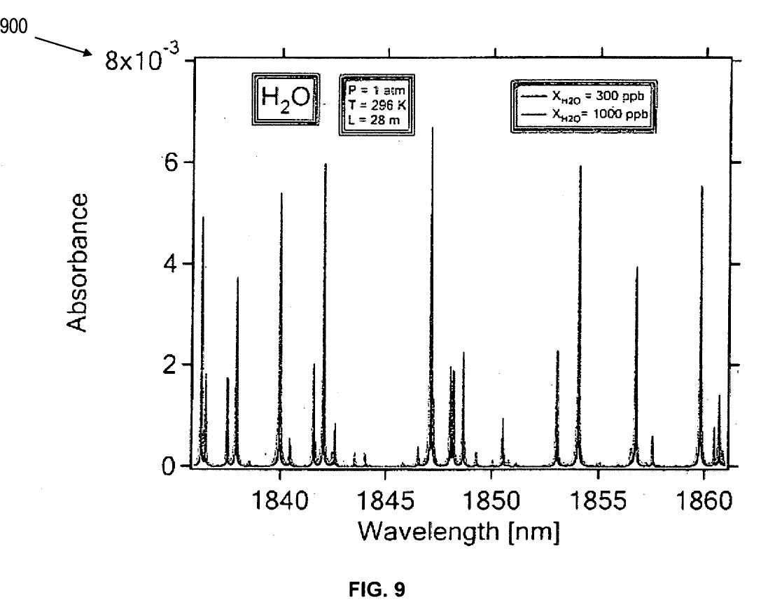

It has been discovered that accurate measurements of water vapor in single composition or nearly pure gas streams can be made using fundamental and vib-rotational combination and overtone bands of water molecules at wavelengths near about 1.4 μm, 1.9 μm, and 2.7 μm. These measurements can be made at selected wavelengths within the ranges of approximately 1359 to 1395 nm, 1836 to 1907 nm, and 2570 to 2750 nm. FIG. 8 shows a chart 800 of absorption peaks for water vapor in the 1359-1395 nm range, while FIG. 9 shows a chart 900 of absorption peaks for water vapor in the 1836-1861 nm range In one variation, measurements can be made using an absorption path length of greater than or equal to approximately 40 cm and at approximately atmospheric pressure. The specific absorption transitions for measurement of water vapor in various single composition or otherwise nearly pure background gases are summarized in Table 1. Other wavelength ranges may also be utilized provided that water molecules absorb light at a greater level than do background gas molecules. Selection of an individual absorption line may be completed using a Figure of Merit (FOM), which is defined as the absorption of 1 ppmv water vapor divided by the total background absorption for the gas to be sampled. All water vapor lines satisfying an FOM of approximately greater than or equal to 1×10⁻⁶ are suitable for sensitive detection of water vapor. Such wavelengths can also be used for measurement of low water vapor concentrations noted above. A TDLAS spectrometer with a single-beam arrangement can be employed as described above. Here, the sample gas is flowed through a sample cell while the laser wavelength is altered using the techniques described above. This wavelength scan across the absorption line of interest and directed at a detector which detects a “2f” signal. Similar spectroscopic techniques used in the past have not been successful in measuring water vapor in single composition or other nearly pure gas streams to these levels of accuracy. This is because suitable absorption lines had not been determined.

TABLE 1
Examples of absorption transitions for measurement of water vapor.
1359.5 nm
1361.7 nm
1368.6 nm
1371.0 nm
1392.0 nm
1836.3 nm
1840.0 nm
1842.1 nm
1847.1 nm
1854.0 nm
1856.7 nm
1859.8 nm
1877.1 nm
1890.3 nm
1899.7 nm
1903.0 nm
1905.4 nm
2573.6 nm
2583.9 nm
2596.0 nm
2605.6 nm
2620.5 nm
2626.7 nm
2630.6 nm
2665.1 nm
2676.0 nm
2711.2 nm
2724.2 nm
2735.0 nm
2740.0 nm

The absorption cell can be maintained to a single temperature to within ±1° C. and used at 1 atmosphere. Temperature control can be accomplished by placing the spectrometer in a thermally controlled enclosure who's interior is insulated and temperature is held above 30° C. in conditions where the environment can vary from −15° C. to +60° C.

The subject matter described herein can be embodied in systems, apparatus, methods, and/or articles depending on the desired configuration. In particular, various aspects of the subject matter described herein can be realized in digital electronic circuitry, integrated circuitry, specially designed application specific integrated circuits (ASICs), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the term “machine-readable medium” refers to any computer program product, apparatus and/or device (e.g., magnetic discs, optical disks, memory, programmable logic devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Although a few variations have been described in detail above, other modifications, additions, and implementations are possible are within the scope and spirit of the disclosed subject matter. Features implementing functions can also be physically located at various positions, including being distributed such that portions of functions are implemented at different physical locations. Further features and/or variations can be provided in addition to those set forth herein. For example, the implementations described above can be directed to various combinations and subcombinations of the disclosed features and/or combinations and subcombinations of several further features disclosed above. In addition, the logic flow depicted in the accompanying figures and/or described herein do not require the particular order shown, or sequential order, to achieve desirable results.

What is claimed

1. A method of detecting trace amounts of water vapor in a high purity gas, comprising:
directing a beam of light at a selected wavelength through a high purity gas comprising water vapor at low concentrations, the selected wavelength coinciding with a water vapor absorption feature that is resolvable from an absorption background of the high purity gas;
quantifying an absorption at the selected wavelength in the high purity gas over a path length;
determining a water vapor concentration in the high purity gas based on the quantified absorption; and
promoting the determined water vapor concentration.

2. A method as in claim 1, wherein the promoting comprises one or more of displaying, transmitting, or storing the determined water vapor concentration.

3. A method as in claim 1, wherein the gas mixture is contained within a sample cell that provides the path length.

4. A method as in claim 1, wherein the absorption at the selected wavelength is quantified with a photodetector that provides a detector output signal to a microprocessor.

5. A method as in claim 2, further comprising:
generating light with a range of wavelengths, the range of wavelengths comprising the selected wavelength;
tuning the generated light across the range of wavelengths; and
converting a DC signal from a photodetector that the light beam impinges upon after traversing the high purity gas to an absorption spectroscopy signal by demodulating the DC signal; and
analyzing the absorption spectroscopy signal to determine the water vapor concentration.

6. A method as in claim 5, wherein the quantifying of the absorption at the selected wavelength is accomplished using one of direct absorption spectroscopy, harmonic spectroscopy, photoacoustic spectroscopy, cavity ringdown spectroscopy, integrated cavity spectroscopy, and cavity enhanced spectroscopy.

7. A method as in claim 1, wherein the water vapor concentration is less than or equal to approximately 1 ppm.

8. A method as in claim 1, wherein the water vapor concentration is less than or equal to approximately 0.1%.

9. A method as in claim 1, wherein the selected wavelength is in a range of about 1359 to 1395 nm, about 1836 to 1907 nm, or about 2570 to 2750 nm.

10. A method as in claim 1, wherein the selected wavelength is chosen such that absorption of 1 ppmv of water vapor at the selected wavelength and a measurement pressure divided by a total background absorption of the high purity gas at the selected wavelength and the measurement pressure is greater than 1×10⁻⁶.

11. A method as in claim 1, further comprising providing the beam of light from a tunable diode laser that is tuned to provide a range of wavelengths comprising the selected wavelength.

12. A method as in claim 1, further comprising maintaining the gas mixture and the photodetector at a constant temperature within a tolerance of approximately ±1° C.

13. An apparatus comprising:
a laser light source that emits a light beam comprising a selected wavelength that coincides with a water vapor absorption feature that is resolvable from a gas absorption background of a high purity gas;
a sample cell to contain the high purity gas containing water vapor at a concentration of less than or equal to approximately 0.1%, the sample cell providing a path length of greater than or equal to approximately 40 cm for the light beam through the high purity gas;
a photodetector positioned to quantify an intensity of light traversing the path length and to output a direct current data signal based on the quantified intensity; and
a microprocessor configured to receive and interpret the direct current signal from the photodetector and to determine the water vapor concentration in the high purity gas based on the direct current data signal.

14. An apparatus as in claim 13, wherein the water vapor concentration is less than or equal to approximately 1 ppm

15. An apparatus as in claim 13, wherein the selected wavelength is in a range of about 1359 to 1395 nm, about 1836 to 1907 nm, or about 2570 to 2750 nm.

16. An apparatus as in claim 13, wherein the selected wavelength is chosen such that absorption of 1 ppmv of water vapor at the selected wavelength and a measurement pressure divided by a total background absorption of the high purity gas at the selected wavelength and the measurement pressure is greater than 1×10⁻⁶.

17. An apparatus as in claim 13, wherein the laser light source is a tunable diode laser that emits light within a wavelength range that comprises the selected wavelength.

18. An apparatus as in claim 17, wherein the laser light source is modulated based on a modulation signal provided by the microprocessor and wherein the microprocessor is configured to demodulate the direct current signal from the photodetector to generate an absorption spectroscopy signal that is analyzed to determine the intensity of light traversing the path length at the selected wavelength.

19. An apparatus as in claim 17, wherein the laser light source is selected from a vertical cavity surface emitting laser, a horizontal cavity surface emitting laser, a quantum cascade laser, a distributed feedback laser, and a color center laser.

20. An apparatus as in claim 13, further comprising a thermally controlled chamber that encloses one or more of the laser source, the photodetector, and the sample cell.

21. An apparatus as in claim 13, wherein the sample cell comprises two reflective mirrors configured to reflect the light beam between them one or more times before the light beam reaches the photodetector.

22. A method of detecting trace amounts of water vapor, comprising:
generating a beam of light comprising a selected wavelength from a tunable laser, the selected wavelength being selected such that absorption of 1 ppmv of water vapor at the selected wavelength divided by absorption by the high purity gas at the selected wavelength is greater than 1×10⁻⁶;
directing the beam of light through a high purity gas comprising water vapor at a concentration of less than or equal to approximately 0.1%;
quantifying an absorption at the selected wavelength in the high purity gas over a path length of greater than or equal to approximately 40 cm and at a pressure of approximately 1 atmosphere; and
determining a water vapor concentration in the high purity gas based on the quantified absorption.

23. A method as in claim 22, further comprising providing the beam of light from a tunable diode laser that is tuned to provide a range of wavelengths comprising the selected wavelength.
